(19) United States
(12) Patent Application Publication
(10) Pub. No.: US 2006/0176021 A1
(43) Pub. Date: Aug. 10, 2006

(54) Electronic device with main current limit circuit

(76) Inventor: James O. Krause, Norcross, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/051,919

(22) Filed: Feb. 4, 2005

(51) Int. Cl. H02J 7/00

(52) U.S. Cl. 320/128

(57) ABSTRACT

This invention includes an electronic device that has both electrical contacts for coupling to local, application specific circuitry and contacts for supplying power to another electronic device. The electronic devices may be coupled in series, so as to eliminate the need for bulky, unsightly cables or wires. Since the devices may be coupled in series ad infinitum, the possibility exists that the series combination of devices may draw more power than either a power source can provide or sensitive internal circuitry, like fuses for example, can handle. As such, each electronic device includes a current limiting circuit having a current sense circuit and a switch coupled serially between the input and the output that powers the next electronic device. When the current drawn from the input to the output supplying power for the downstream devices exceeds a predetermined threshold, the switch deactivates the upstream chargers local circuitry. Once the downstream devices have completed their desired activities, the current drawn by the downstream devices will be reduced. When this occurs, the current sense circuits of the upstream devices will detect that the total current drawn has fallen below the predetermined threshold and will once again reactivate their local circuitry. In one embodiment, the electronic devices are desktop battery chargers. By disabling upstream battery chargers while downstream battery chargers complete their charging cycle, the current limiting devices in the upstream battery chargers ensure that fuses disposed within the upstream battery chargers do not blow. A blown fuse in an upstream charger could result in the entire series combination losing power. By including the current limiting circuit of the invention, a user may couple as many series devices together as they want without fear of blowing fuses in the upstream devices.

### BACKGROUND

1. Technical Field

This invention relates generally to an electronic device having current limiting circuitry, and more specifically to an electronic device that is capable of supplying power to both local circuitry and a plurality second device, the electronic device having a current limit circuit that disables the local circuitry when the current drawn by the plurality of devices exceeds a predetermined threshold.

2. Background Art

In modern day life, clusters of electronic devices are everywhere. For example, in the family living room, the entertainment system may consist of many devices linked together with wires and cables. A television may be connected to a variety of devices, including a VCR, a DVD player, a TiVo® system, a surround sound system, amplifiers and speakers. By connecting this variety of devices together, one may use the collective assembly of devices for hours and hours of entertainment.

Similarly, in the office, multiple electronic devices are coupled together. A personal computer may be connected to a monitor, printer, scanner, mouse, digital camera, MP3 player, and power supply. The collection of devices offers more functionality than any one of the devices standing alone.

The problem with these “clusters” of devices is that they must all be interconnected with cables or wires. While any one cable may appear thin and non-bulky, multiple cables, criss-crossing each other may resemble a tangled mess. Often this “rat's nest” of wire can be unsightly and difficult to conceal. Sometimes, for example, when they hang over the edge of a desk, a tangled bunch of wires may even constitute an obstacle over which one may trip.

To rectify this tangled cable nightmare, some manufacturers have begun to build devices that may be connected together in series. For example, while the Apple ipod® can be charged from the wall directly, one may also couple an iBook® computer to a wall outlet, and then couple the iPod® to the computer. The wall outlet provides power to the iBook®, and the iBook® provides power to the ipod®. Thus the devices are connected serially to one another.

When this serial “power train” is limited to two or three devices, there is generally no problem. However, for devices that may be coupled serially ad infinitum, a problem exists in that the serial chain may become so long that the power being drawn by the series combination overwhelms either the power source or the device's internal circuitry, which may include sensitive electronics, wiring or fuses. In other words, while the wall outlet might be able to supply power to four or five devices coupled in series, coupling forty or fifty devices together may cause all kinds of power overload problems, including blown fuses and tripped circuit breakers. No one wants to sit around in the dark just because some smart-aleck thought it would be funny to connect a hundred devices in series and plug them into the wall.

There is thus a need for an electronic device that, when coupled in a serial chain, is capable of limiting the combined power drain of the serial combination a predetermined threshold.

### BRIEF DESCRIPTION OF THE DRAWINGS

FIG. 1 illustrates one preferred embodiment of a gangable electronic device with main current limit circuit in accordance with the invention.

FIG. 2 is a schematic diagram illustrating one preferred embodiment of a current limiting circuit in accordance with the invention.

FIG. 3 is a schematic block diagram illustrating a plurality of gangable electronic devices with main current limit circuits coupled together in series in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention includes an electronic device, like a desktop battery charger for example, that may be coupled together serially with other similar devices. For example, one charger may be coupled to another identical charger, and so on, to form a multi-unit charger from a plurality of single unit chargers. This serial coupling, sometimes referred to as a “daisy chain configuration”, allows multiple devices, like chargers, to be coupled directly together in series without the need for unsightly cables.

In one preferred embodiment of the invention, the electronic device is a desktop battery charger having input terminals capable of coupling to a power source. The charger additionally has at least one set of output terminals for coupling to a second electronic device, such as a another identical charger. Input power, for example power from an AC voltage source such as a wall outlet, is coupled to the input terminals and is passed through to the set of output terminals such that a second electronic device or charger may be coupled to and powered from this set of output terminals. Since, in theory, there is no physical limit to the number of chargers that may be coupled together in series, each charger includes a current limiting circuit that limits the total current being drawn by the series string of devices.

The current limiting circuit includes a current sensing circuit that senses the total current drawn by the output terminals, as well as a current limiting device coupled between the input terminal and the local charging circuitry. When the current flowing from the input terminal to the output terminal increases above a predetermined threshold, the current limiting circuit actuates the current limiting device to disable local charging circuitry. This disabling of the local charging circuitry is done to prevent the combined series of devices from drawing more power than the supply can source. Other down stream devices will additionally disable their local charging circuitry until a sufficient number of devices are deactivated such that the total power drawn by the series string falls within the limits of the power source.

In one preferred embodiment, each battery charger includes a power supply and a current limiting circuit as well as an AC input and an AC output power connector. A first charger is connected to an AC power source, such as a wall outlet, by standard power cord. A second charger is coupled directly to the first charger such that the AC input of the second charger is coupled to the AC output of the first charger. Additional chargers may be coupled to this first series pair. Since the input and output connectors are uniform, more and more chargers could be coupled in series, theoretically without a physical limit. The local charging circuitry of each charger in the series string, which may include a DC power supply, is connected directly to the input AC power connector of that particular charger.

A current limiting circuit is disposed within each charger in the series group. The current limiting circuit may include a current sense circuit, like a transformer for example, that senses the current flowing from the AC input of that particular charger to its AC output. When the current flowing from the AC input to the AC output of that charger exceeds a predetermined threshold, the current limiting circuit actuates a current limiting device to turn off, deactivate or otherwise disable the local charging circuitry, thereby reducing the overall power drawn by the series connection of chargers.

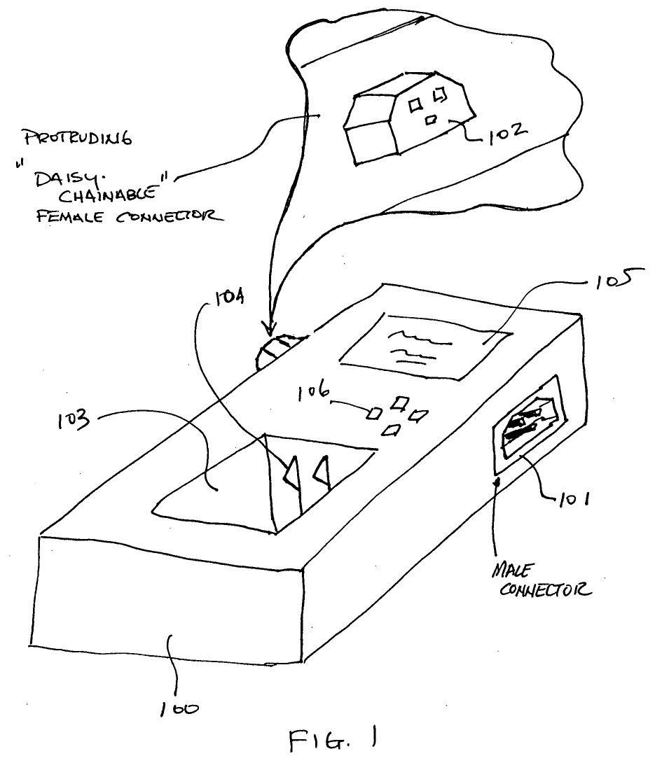

Turning now to FIG. 1, illustrated therein is one preferred embodiment of a gangable electronic device with main current limit circuit in accordance with the invention. For discussion purposes, a desktop battery charger will be used as the electronic device, although it will be clear to those of ordinary skill in the art having the benefit of this disclosure that the invention is not so limited. The invention could be equally applied to numerous other electronic devices including audio and visual electronics, computer peripherals, appliances, and other similar devices.

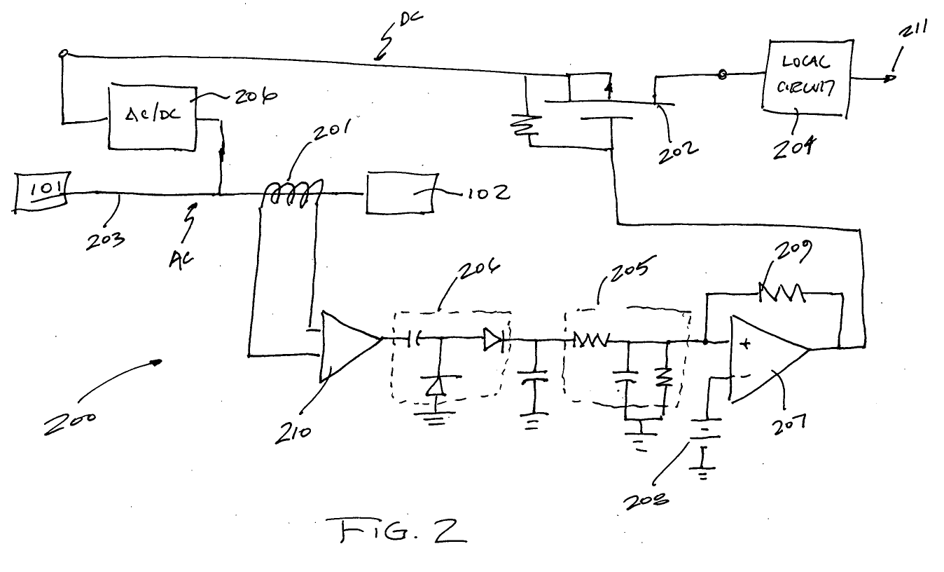

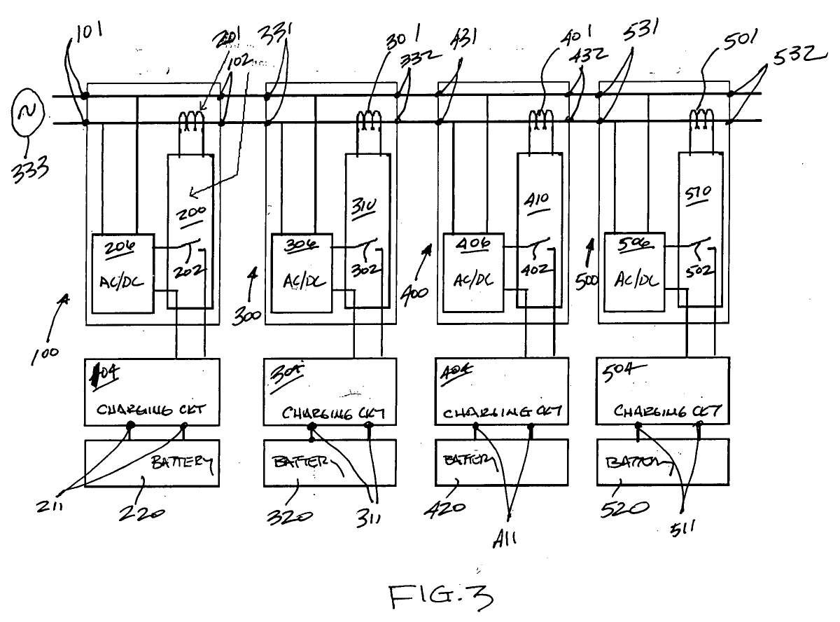

The charger 100 of FIG. 1 includes an input coupling or terminal 101 capable of receiving power from an external power source. The charger 100 also includes a first set of output terminals 102 for supplying power to another, possibly similar, electronic device. The input 101 and output 102 are coupled by a “pass through” circuit as will be seen in the discussion of FIGS. 2 and 3.

The charger 100 additionally includes a second set of output terminals 104 for performing a local function, like coupling to a rechargeable battery pack. Local application specific circuitry, such as battery charging circuitry, is coupled between the input 101 and the second output 104. The battery charging circuitry may include an AC to DC converter and other charging circuitry that may ramp, step, taper, or otherwise modulate the output voltage and current to properly charge the rechargeable battery pack.

In one preferred embodiment, input 101 and output 102 are designed with complimentary mechanical features so as to couple together without the need of unsightly cables or wires. For example, if input 101 is a three terminal male connector having a pentagonal female shroud, output 102 may be a three terminal female connector with a pentagonal male shroud. The charger 100 may additionally include other features such as a pocket 103 for receiving a rechargeable battery. A display 105 or other indicator, such as light emitting diodes (LEDs) 106, may be included to provide the user with an indication of charging progress.

Turning now to FIG. 2, illustrated therein is one preferred embodiment of a current limiting circuit 200 in accordance with the invention. The current limiting circuit 200 includes a current sensing circuit 201 that senses the magnitude of current flowing through a pass-through circuit 203. The pass-through circuit 203 is coupled between the input 101 and first output 102. The pass-through circuit facilitates power flow from the input 101 to the first output 102, such that first output 102 is capable of supplying power to another electronic device.

A current limiting device 202 is coupled serially between the input 101 and a second output 211. The second output 211 may be coupled to local circuitry 204, such as battery charging circuitry for example. When the current sensing circuit 201 detects that the current drawn by the first set of output terminals 102 exceeds a predetermined threshold, a threshold that may correspond to the supply limits of the external power source for example, the current limiting device 202 is actuated. The actuation of the current limiting device 202 disables the local circuitry 204 so as to reduce the overall power drawn by the series connection of electronic devices.

By way of example, an AC power source may be coupled to input terminal 101. Power from this AC power source is passed through the pass-through circuit 203 to output terminal 102. Current sensing circuit 201 monitors the amount of current being drawn from the input terminal 101 to the output terminal 102. When this current exceeds a predetermined threshold, like 5 Amps for example, the current limiting circuit 200 will actuate the current limiting device 202, thereby disabling the local charging circuit 204. In so doing, the current limiting circuit 200 ensures that the total power drawn from the power source does not exceed the capability of the power source. Note that in this particular embodiment, an AC to DC converter 206 is coupled between the input 101 and the second set of output terminals 211 to convert the AC power coming from the external power source into a DC voltage a current suitable for charging a rechargeable battery pack.

The current sensing circuit 201 may be selected from any of a variety of devices, including transformers, such as toroidal coils, and Hall effect sensors. The current sense circuit 201 then feeds its sensed current value to an optional amplifier 210. The output of the amplifier 210 is coupled to a peak voltage detector 206, which is coupled to a delay circuit 205. The delay circuit 205 provides filtering, in that the delay prevents short spikes of current from causing nuisance trips of the current limiting device 202. This filtered current sense signal is then fed into comparator 207, where it is compared with a reference voltage 208. (The reference voltage 208 is chosen to be proportional to the predetermined current limit threshold.) The comparator 207 includes positive feedback 209 that offers hysteresis, to prevent any unstable, switching states of the current limiting device 202 at the comparator's threshold crossing points. The output of the comparator 207 is coupled to the current limiting device 202, and is capable of actuating the current limiting device 202, thereby causing the current limiting 202 device to enter either high impedance or low impedance states.

In one preferred embodiment, the current limiting device 202 is a P-channel Field Effect Transistor (FET). It will be clear to those of ordinary skill in the art having the benefit of this disclosure that other devices, including N-channel FETs, bipolar and other types of transistors, switches, relays, circuit breakers, resettable fuses, and other similar devices, may be substituted for FET 202.

Turning now to FIG. 3, illustrated therein are four chargers coupled in series in accordance with the invention. While four devices is chosen for exemplary purposes, the same discussion could be carried out with any number of devices. Each charger 100, 300, 400, 500 includes a current limiting circuit 200, 310, 410, 510 therein. Each current limiting circuit 200, 310, 410, 510 includes a corresponding current sense circuit 201, 301, 401, 501 and a current limiting element 202, 302, 402, 502, respectively.

Each charger 100, 300, 400, 500 has an input 101, 331, 431, 531 for receiving power and an output 102, 332, 432, 532 capable of powering another similar device. In FIG. 3 a first charger 100 has an AC power source 333 coupled to its input 101. The input 331 of the second charger 300 is coupled to the output 102 of the first charger 100. Similarly, the input 431 of the third charger 400 is coupled to the output 332 of the second charger. The input 531 of the fourth charger is coupled to the output 432 of a third charger. Within each charger 100, 300, 400, 500 is disposed local charging circuitry including an AC to DC converter 206, 306, 406, 506 and charging circuitry 104, 304, 404, 504.

Each charger 100,300,400,500 further includes a second set of electrical contacts 211,311,411,511. These optional contacts 211,311,411,511 may be used, for example, for coupling to a rechargeable battery 220,320,402,520.

Assume for the purposes of this discussion that the current limit threshold is set such that three chargers coupled in series may operate normally, but a fourth charger coupled to the series group would cause the total power drawn by the four chargers coupled in series to exceed the output capability of the power source 333 (or internal fuses or circuitry within the device). Assuming this, when the fourth charger 500 is coupled to the series string, the current sense element 201 in the first charger 100 will sense that the power being drawn by the three chargers 300, 400, 500 downstream is at the maximum available for supply from the power source 333. As such, the current limit circuit 200 of the first charger 100 will actuate its current limiting device 202, thereby deactivating the local charging circuit 104. In so doing, the current limit circuit 200 of the first charger 100 allows the local charging circuitry 304, 404, 504 of the three downstream chargers 300, 400, 500 to fully charge the batteries attached thereto 320, 420, 520.

When any one of those chargers 300, 400, 500 completes its charging process, the current sense circuit 201 of the first charger 100 will detect that the total current drawn by the three downstream chargers 300, 400, 500 is below the predetermined threshold. At that point, the current limit circuit 200 of the first charger 100 will close the current limit switch 202, thereby reactivating its local charging circuitry 104 so as to charge the attached battery 220.

The gangable electronic device with current limiting circuitry of the present invention has numerous advantages over conventional devices. For example, if electronic devices without the current limit of the present invention were allowed to be daisy chained ad infinitum, the series string could become so long that the power drawn by the series string could overwhelm the power source. This excessive string of series coupled devices could result in a blown fuse of the first charger, and possibly additional chargers, in the series string.

A blown fuse in the pass-through circuit of one of the chargers could result in a loss of power to the entire string of series coupled chargers. Such a blown fuse would require the user to replace the fuse before any of the chargers would work properly. This would be not only an inconvenience to the end user, but would be time consuming and costly as well. By including the current limit circuit of the present invention, upstream chargers are able to disable their local circuitry, thereby keeping the power drawn by the series string of chargers within the limits of the input power source. As such, a user may string together an unlimited number of chargers while ensuring that fuses within each charger would not clear.

In summary, in one embodiment, the invention includes an electronic assembly comprising a plurality of electronic devices, such as desktop battery chargers. Each electronic device includes an input for receiving power and a first output for coupling to another electronic device. The first output is capable of supplying power to the second device. Each electronic device also includes a second output for supplying power to a local circuit. Each electronic device further includes a current limiting circuit. The current limiting circuit includes a current sense circuit and a current limiting device that is coupled serially between the input connection and the second output connection which is coupled to the local circuitry. When a current being drawn by the first output exceeds a predetermined threshold, the current limiting device deactivates the local circuitry thereby reducing the current drawn by the series of electronic devices.

In one preferred embodiment, the local circuit is a battery charging circuit for a desktop battery charger. Where the electronic device is a desktop charger, the received power at the input and the supply power at the first output may include alternating current, for example from an power source such as a conventional wall outlet. In the charging embodiment, the power supply to the second output may include direct current, for example from an AC/DC converter. The current limiting circuit within each electronic device turns off the power to its local circuit when the power drawn by the first output exceeds a predetermined threshold. When the chargers downstream complete their charging cycles and thus reduce their power requirements, the upstream chargers sense that the power being drawn by the series strings has reduced. The upstream chargers will then reactivate their local charging circuitry to re-enable attached batteries to resume charging.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. An electronic device, comprising:
a. input terminals capable of coupling to a power source;
b. local circuitry for performing a predetermined function within the device;
c. at least one set of output terminals for coupling to a second electronic device; and
d. a current limiting circuit that limits a total current drawn by the device and any other devices coupled thereto; the current limiting circuit comprising:
i. a current sensing circuit; and
ii. a current limiting device coupled in series between the input terminals and the local circuitry;
wherein when the current sensing circuit detects the current drawn by the at least one set of output terminals exceeds a predetermined threshold, the current limiting device is actuated.

2. The device of claim 1, wherein the current limiting circuit further comprises a delay circuit coupled between the current sensing circuit and the current limiting device.

3. The device of claim 2, wherein the current limiting device is selected from the group consisting of transistors, switches, relays, circuit breakers and resettable fuses.

4. The device of claim 1, wherein the electronic device comprises a rechargeable battery charger.

5. A battery charger, comprising:
a. an input coupling capable of receiving power from a power source;
b. a pass through circuit coupling the input to a first set of output terminals;
c. a second set of output terminals for coupling to battery charging circuitry; and
d. a current limiting circuit, comprising:
i. a current sensing circuit; and
ii. a switch coupled serially between the input and the second set of output terminals;
wherein when a current drawn by the first set of output terminals exceeds a predetermined threshold, the switch deactivates the second set of output terminals.

6. The charger of claim 5, wherein the current limiting circuit further comprises a comparator coupled between the current sensing circuit and the switch.

7. The charger of claim 6, wherein the current sensing circuit is selected from the group consisting of Hall effect sensors and transformers.

8. The charger of claim 7, wherein the switch device is selected from the group consisting of transistors, switches, relays, circuit breakers and resettable fuses.

9. The charger of claim 8, wherein the current limiting circuit further comprises a delay circuit coupled between the current sensing circuit and the switch.

10. The charger of claim 9, wherein the current limiting circuit further comprises a peak voltage detector.

11. An electronic assembly, comprising a plurality of electronic devices, each electronic device comprising:
a. an input for receiving power;
b. a first output for coupling to another electronic device, the first output capable of supplying power to the another device;
c. a second output for supplying power to a local circuit; and
d. a current limiting circuit, the current limiting circuit comprising:
i. a current sensing circuit; and
ii. a current limiting device coupled serially between the input connection and the second output connection;
wherein when a current being drawn by the first output exceeds a predetermined threshold, the current limiting device deactivates the local circuit.

12. The assembly of claim 11, wherein the local circuit comprises a battery charging circuit.

13. The assembly of claim 12, wherein each of the electronic devices is identical.

14. The assembly of claim 11, wherein both the received power at the input and the supplied power at the first output comprise alternating current.

15. The assembly of claim 14, wherein the power supplied at the second output comprises direct current.

16. The power supply of claim 15, wherein the current limiting device is selected from the group consisting of transistors, switches, relays, circuit breakers and resettable fuses.

17. The power supply of claim 16, further comprising a comparator coupled between the current sensing circuit and the current limiting device.

18. The power supply of claim 17, further comprising a delay circuit coupled between the current sensing circuit and the current limiting device.
